(19) United States
(12) Patent Application Publication
(10) Pub. No.: US 2025/0050277 A1
(43) Pub. Date: Feb. 13, 2025

(54) POTTING MATERIAL FOR MEMBRANE SEPARATION MODULES

(71) Applicant: Whitefox Technologies Limited, London (GB)

(72) Inventors: Thomas MEYER, Bremen (DE); Helmut SCHOLAND, Bremen (DE)

(73) Assignee: Whitefox Technologies Limited, London (GB)

(21) Appl. No.: 18/794,172

(22) Filed: Aug. 5, 2024

Related U.S. Application Data
(60) Provisional application No. 63/531,365, filed on Aug. 8, 2023.

(51) Int. Cl. B01D 63/02; B01D 63/04; B01D 69/02; B01D 69/08; B01D 71/64

(52) U.S. Cl. CPC B01D 63/023; B01D 63/0221; B01D 63/0233; B01D 63/04; B01D 69/02; B01D 69/081; B01D 71/64; B01D 2313/21; B01D 2325/04; B01D 2325/24

(57) ABSTRACT

A potting material as for use in membrane separation modules maybe provided consisting of a tin alloy having a melting point of from 210 to 230° C., wherein the tin alloy consists, on a metals basis, of: from 95 to 97 wt. %; and from 3 to 5 wt. % of the combination of Silver (Ag) with at least one of Nickel (Ni), Copper (Cu), or Germanium (Ge).

### CROSS-REFERENCES TO RELATED APPLICATIONS

The present disclosure claims the benefit of and priority to U.S. Provisional Patent Application No. 63/531,365 titled “POTTING MATERIAL FOR MEMBRANE SEPARATION MODULES” and filed on 2023 Aug. 8, which is incorporated herein it is entirety.

### FIELD

The present disclosure is generally directed to a potting material and to membrane separation modules comprising the potting material. More particularly, the present disclosure is directed to a potting material comprising an alloy, which material is effective as a sealant within membrane separation modules.

### BACKGROUND

Membrane separation is a technology which selectively separates (fractionates) materials via pores and/or minute gaps in the molecular arrangement of a continuous structure. Membrane separations are conventionally classified by pore size and by the separation driving force, the latter of which may be constituted by pressure, concentration gradient, valence or electrochemical affinity. Membrane separation classifications include, but are not limited to: microfiltration (MF); ultrafiltration (UF); ion-exchange (IE); reverse osmosis (RO); dialysis; electrodialysis; gas separation; vapor permeation; pervaporation; and membrane distillation. Additionally, membrane separation has found utility in applications as divergent as purification, diafiltration, desalination, dehydration, fluid sterilization, and fluid clarification.

Membranes are typically provided within a module or modular cartridge which allows the membranes to be facilely repaired or replaced during use. Such a modular cartridge may be constituted by a housing in which at least one membrane is disposed and affixed using a potting material, said potting material often being provided in the form of headers spaced apart within the housing. Such housed membranes are primarily available as hollow fiber membranes, capillary fiber membranes, tubular membranes and flat sheet membranes provided in either pleated, stacked or spiral wound configurations.

The potting material is used inter alia to seal the overall membrane module and to stabilize the membranes thereof. Further, the potting material ensures that the product streams and feed streams of the module do not mix and that any applied pressure or vacuum can be maintained. Consequently, for many applications, any defect in the seal provided by these materials will be determinative of the operational life of the membrane module.

Potting materials based on polyurethanes are known in the art. The isocyanates used in such conventional polyurethane compositions present an acknowledged toxicological risk. This relates, on the one hand to the processing of these coating materials during their use, because the isocyanates normally have a high toxicity and a high allergenic potential (OSHA Safety and Health Topics: Isocyanates https://www.osha.gov/SLTC/isocyanates/). On the other hand, there is the risk that, in porous substrates, incompletely reacted aromatic isocyanate migrates through the substrate and is there hydrolyzed by moisture or water-containing components to carcinogenic aromatic amines.

In the presence of moisture, curing polyurethane generates carbon dioxide which forms bubbles in the curing material: this foam causes the material to expand as the material hardens, weakening the cured material and leading to potential leaks in the finished material. To obviate this effect, moisture should be eliminated from the potting process but of course the need for climate control and/or drying agents adds complexity and cost to the manufacture of filters.

Potting materials based on epoxy resins are also known. Such epoxy resins may not possess susceptibility to moisture. However, epoxy resins generate heat during their curing which causes the epoxy to expand as it cures but contract as it cools following the completion of the reaction. The cooling can create stresses and voids in the finished cast and promote cracking and other flaws. These effects can be mitigated either by slowing the curing reaction to reduce the amount of generated or by cooling the material as the material cures to reduce thermal expansion. Problematically, slowing the process will increase process lead time and reduce manufacturing efficiency, while cooling adds both complexity and cost to the potting operation.

### SUMMARY

In accordance with an aspect of the disclosure, there is provided the use in a membrane separation module for withdrawing permeate from a multicomponent fluid feed of a membrane potting material consisting of a tin alloy having a melting point of from 210 to 230° C., wherein the tin alloy consists, on a metals basis, of: from 95 to 97 wt. % Sn; and from 3 to 5 wt. % of the combination of Ag with at least one of Ni, Cu, or Ge.

The present disclosure provides a viable alternative to the use of polyurethane and epoxy compositions in membrane separation modules. The tolerance of the recited potting material to elevated temperature provides for its utility in membrane separation modules which are to be employed at operating temperatures above room temperature, such as above 75° C. For example, the potting material may be used with membranes which are to be employed in the dehydration of mixtures of water with C₁-C₄ alkanol—such as are obtained in cellulose-to-biofuel plants—and for which the operating temperatures are conventionally greater than 125° C.

It is considered that the potting material may be utilized in modular membranes either of a self-contained configuration or of the open-immersion type. As self-contained (or housed) membrane modules are the most common configuration for microfiltration, ultrafiltration, nanofiltration and reverse osmosis (RO), they are the primary focus of the present disclosure but it will be recognized that the in situ application of the potting material to a framed or supported membrane module—which is otherwise exposed to the liquid medium in which it is disposed—is also envisaged.

In accordance with an aspect of the present disclosure, there is provided a header assembly for a housed membrane separation module including: a plurality of hollow fiber membranes which are arranged together longitudinally to form a bundle having a core axis and defining a first axial length; and a potting material provided as a cast having a second axial length parallel to the core axis of the bundle, wherein the ratio of the second axial length to the first axial length is from 1:5 to 1:50; wherein the potting material encases the bundle with a seal over the second axial length; and further wherein the potting material consists of a tin alloy having a melting point of from 210 to 230° C., wherein the tin alloy consists, on a metals basis, of: from 95 to 97 wt. % Sn; and from 3 to 5 wt. % of the combination of Ag with at least one of Ni, Cu or Ge.

The plurality of membranes may, in some embodiments, consist of a bundle of from 5 to 50000 hollow fiber membranes which are arranged together longitudinally. For example, the plurality of membranes may consist of a bundle of from 1000 to 10000 hollow fiber membranes which are arranged together longitudinally.

In some embodiments, the hollow fiber membranes may be bundled together in a straight form. In other embodiments, the hollow fiber membranes may be interwoven in the bundle. In a still further embodiment, the hollow fiber membranes may chaotically bundled.

The hollow fiber membranes may have a length of at least 0.5 m in some embodiments. Alternatively or additionally, the hollow fiber membranes of the bundle may be characterized by: an outer diameter of from 20 to 2000 microns; a membrane thickness (t) of from 0.1 to 100 microns; and a tensile strength of from 25 to 100 MPa.

In some embodiments, the hollow fiber membranes of the bundle are porous and are further characterized by at least one of the following parameters: a void content of from 50 to 90%, for example from 60 to 90%; a total number of pores of from 1×10⁹ to 1×10¹², for example from 1,000,000,000 to 1,000,000,000,000 per mm length of fiber; a total number of saccate pores of from 0 to 1×10¹², for example from 5 to 500 per mm length of fiber; and a total number of through pores of from 0 to 20,000, for example from 0 to 50 per mm length of fiber.

The present disclosure also provides a method of forming a header assembly for a housed membrane separation module, said method including: preparing a molten potting material consisting of a tin alloy having a melting point of from 210 to 230° C., wherein the tin alloy consists, on a metals basis, of: from 95 to 97 wt. % Sn; and from 3 to 5 wt. % of the combination of Ag with at least one of Ni, Cu or Ge; providing a plurality of hollow fiber membranes which are bundled together longitudinally to form a bundle having a core axis and defining a first axial length, wherein a potting region is defined at one end of the bundle; and introducing the potting region of the bundle into the cavity of a mold having a volumetric capacity; introducing the molten potting material into the cavity of the mold at a temperature of from 225° C. to 275° C. such that the potting material flows around the membranes; and solidifying the potting material in the cavity of the mold; removing the solidified potting material from the mold; and cutting a portion of the solidified potting material to form a cast having a second axial length parallel to the core axis of the bundle, wherein the solidified potting material encases the bundle with a seal over the second axial length.

The cutting step of this process should, in some embodiments, expose the core or lumens of the hollow fiber membranes. The cut section of the cast may further be polished.

In some embodiments of this method, the molten potting material introduced into the mold is subjected to vibration prior to the step of solidifying the potting material. In some embodiments, the vibration has at least one of the following characteristics: a frequency of from 20 kHz to 1 MHz; and a power density of from 10 W/cm³ to 10 MW/cm³, based on the volumetric capacity of the mold. Independently of the applied frequency and power of the vibration, the molten potting material may in some embodiments be subjected to vibration for a duration of from 0.01 to 100 seconds prior to the step of solidifying the potting material.

In some embodiments, in the step of solidifying the potting material in the cavity of the mold, a cooling rate of from 0.5 to 5° C.·s⁻¹ is applied.

In a further aspect of the disclosure, there is provided a membrane separation module for withdrawing permeate from a multicomponent fluid feed, the module comprising: a housing; a plurality of hollow fiber membranes which are bundled together longitudinally to form a bundle having a core axis and defining a first axial length; a first header disposed within the housing, the first header comprising a potting material which is provided as a cast having a second axial length, wherein the ratio of the first axial length to the second axial length is from 1:5 to 1:50; a second header disposed within the housing in a spaced apart relationship from the first header, the second header comprising a potting material which is provided as a cast having a third axial length, wherein the ratio of the first axial length to the third axial length is from 1:5 to 1:50; wherein: the potting material of the first header encases a first end of the bundle over the second axial length; the potting material of the second header encases a second end of the bundle over the third axial length; and the potting material consists of a tin alloy having a melting point of from 210 to 230° C., wherein the tin alloy consists, on a metals basis, of: from 95 to 97 wt. % Sn; and from 3 to 5 wt. % of the combination of Ag with at least one of Ni, Cu or Ge.

The membrane separation module may, in some embodiments, provide a total surface area for permeation of at least 10 m².

In some embodiments of the membrane separation module, the plurality of membranes is selectively permeable to water, carbon dioxide or methane over other gas or liquids.

In some embodiments of the membrane separation module, the plurality of membranes consists of a bundle of from 1000 to 10000 hollow fiber membranes which are bundled together longitudinally, wherein the hollow fiber membranes have an outer diameter of from 200 to 1000 microns, a membrane thickness of from 0.1 to 20 microns and a tensile strength of from 25 to 75 MPa; and further wherein the hollow fiber membranes comprise or consist of a polyimide having a selective permeability for water vapor relative to C₁ to C₄ alkanols.

In some embodiments of the membrane separation module, the plurality of membranes consists of a bundle of from 1000 to 10000 hollow fiber membranes which are bundled together longitudinally, wherein the hollow fiber membranes have an outer diameter of from 200 to 1000 microns, a membrane thickness of from 0.1 to 20 microns and a tensile strength of from 25 to 75 MPa; and further wherein the hollow fiber membranes comprise or consist of a polyimide having a selective permeability for water vapor relative to ethanol (C₂H₅OH).

The potting material defined herein may have utility in the potting of separation membranes other than hollow fiber membrane. In a still further aspect of the present disclosure there is provided a method of making a spiral wound separation module, said spiral wound filtration module comprising a permeate collection tube and a plurality of membrane leaf packets wound about said collection tube, each membrane leaf packet having first and second membrane sheets in between which sheets is disposed a permeate spacer and wherein each said membrane sheet has a membrane side and a backing side, the method including: preparing a molten potting material consisting of a tin alloy having a melting point of from 210 to 230° C., wherein the tin alloy consists, on a metals basis, of: from 95 to 97 wt. % Sn; and from 3 to 5 wt. % of the combination of Ag with at least one of Ni, Cu or Ge; applying the molten potting material at a temperature of from 225° C. to 275° C. onto at least a portion of the backing side of the first membrane leaf; winding the membrane leaf packet(s) around the permeate collection tube; and allowing the potting material to solidify, thereby bonding the backing side of the second membrane leaf to the backing side of the first membrane leaf.

### Definitions

As used herein, various chemical compounds may be referred to by associated element abbreviations set by the International Union of Pure and Applied Chemistry (IUPAC), which one of ordinary skill in the relevant art will be familiar with. Similarly, various units of measure may be used herein, which are referred to by associated short forms as set by the International System of Units (SI), which one of ordinary skill in the relevant art will be familiar with.

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps. If used, the phrase “consisting of” is closed and excludes all additional elements. Further, the phrase “consisting essentially of’ excludes additional material elements but allows the inclusion of non-material elements that do not substantially change the nature of the disclosure.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Further, in accordance with standard understanding, a range represented as being “from 0 to x” specifically includes 0: the feature defined by the range may be absent or may be present in an amount up to x wt. %.

The words “preferred”, “preferably”, “desirably”, “optionally” and “particularly” may be used herein to refer to embodiments of the disclosure that may afford particular benefits, under certain circumstances. However, the recitation of one or more preferable, preferred, desirable, optional or particular embodiments does not imply that other embodiments are not useful and is not intended to exclude those other embodiments from the scope of the disclosure.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

As used throughout this application, the word “may” is used in a permissive sense—that is meaning to have the potential to—rather than in the mandatory sense.

The term “plurality” as used herein, is defined as two or more than two.

As used herein, “room temperature” is 23° C. plus or minus 2° C. As used herein, “ambient conditions” means the temperature and pressure of the surroundings in which the composition is located or in which a coating layer or the substrate of said coating layer is located.

As used herein, the terms “applied on”, “disposed on”, “deposited on”, “deposited over” or “overlaid’ mean respectively applied, disposed, deposited and overlaid on but not necessarily in contact with the stated surface. For example, a component “disposed on” a substrate does not preclude the presence of one or more other intermediate component of the same or different type located between the component and the substrate.

As used herein, the term “potting material” is intended to denote a material that can be used to hold a membrane, such a spiral wound membrane or hollow fiber membrane in a fixed positional relationship. For example, the potting material will hold a plurality of hollow fiber membranes in a fixed positional relationship with one another, where applicable. The potting material may also serve to direct feed, filtrate, concentrate and retentate flow in, around and through the membrane.

As used herein, the term “alloy” refers to a substance composed of two or more metals or of a metal and a non-metal which have been intimately united, usually by being fused together and dissolved in each other when molten. The terms “tin alloy” or “Sn alloy” denotes an alloy of which tin (Sn) is the major constituent component, which tin will generally comprise at least 60 wt. %—more typically at least 75 wt. % or at least 90 wt. %—of the alloy, on a metals basis. Metals which may be alloyed with tin include, but are not limited to: germanium (Ge); silver (Ag); nickel (Ni); copper (Cu); bismuth (Bi); and antimony (Sb).

For notational purposes, where a tin (Sn) alloy is expressed herein in the form Sn_{α}Ag_{β} or Sn_{α}Ge_{γ}, it should be understood that: a denotes the percentage by weight on a metals basis of Sn in the alloy; R denotes the percentage by weight on a metals basis of Ag in the alloy; and γ denotes the percentage by weight on a metals basis of Ge in the alloy. Similar notation with analogous interpretations may be used herein for other alloys.

Where an alloy is expressed herein in the form NiGeSn_{(100-δ)}Ge_{δ}, it is understood that Ni, Sn and Ge are present in the alloy: the alloy may be obtained by the addition of Ge in an amount, on a metals basis, of 6 percent by weight of the final alloy to a combination of Ni, Sn and Ge metals, which combination constitutes, on a metals basis, (100-6) percent by weight of the final alloy. This notation is used to reflect that the combination may represent a pre-formed alloy to which Ge is added as an adjunct material.

The term “C₁-C₄ alkanol” as used herein refers to an alkane having from 1 to 4 carbon atoms wherein one or more hydrogens of the alkane has been substituted with a hydroxyl group. Exemplary C₁-C₄ alkanols include: methanol; ethanol; isopropanol; n-propanol; sec-butanol; isobutanol; and tert-butanol.

The term “bundle” as used herein refers to plurality of tubes, fibers, filaments or capillaries of substantially the same length which are grouped together. The bundle possesses a longitudinal axis which may be arcuate but is preferably linear.

The “longitudinal axis” of a fiber—or like elongate structure—spans the geometric center of the cross-section of the first end (or base) of the fiber and the geometric center of the cross-section of the second end (or tip) of the fiber. In some embodiments the longitudinal axis may be a substantially straight line. In other embodiments, the axis may be curved or bent.

The term “header” is used herein in the context of a filtration module to specify a solid body in which a plurality of membranes may be affixed and sealingly secured to preclude contamination of the permeate with the feed to the module.

The term “mold” as used herein refers to a shaping member wherein the material to be shaped or cast can be introduced by pouring or injection with or without the aid of pressure. In the present disclosure, the mold should be characterized by a coefficient of thermal expansion of less than 2×10⁻⁵ K⁻¹ or less than 1.5×10⁻⁵ K⁻¹: the use of aluminum and stainless steel molds may be mentioned. In use, the internal surface(s) of the mold may be provided with a release agent to facilitate the removal of the cast or shaped material therefrom. In some embodiments of the disclosure at least a portion of the mold will have a cylindrical shape.

The term “cylindrical” as used herein means a three-dimensional object that is obtained by taking a circular two-dimensional area and projecting it in one direction so that the resulting three-dimensional object has the same cross-sectional size and circular shape at any location along its length.

“Vibration” as used herein refers to an oscillatory movement wherein portions of an object move alternately in opposite directions from a position of equilibrium.

The term “vibration imparting device” is used herein to denote a device for subjecting a member to a controlled and reproducible vibration. Vibration imparting devices which may have utility in the present disclosure may be classified according to: the drive used, in particular whether the drive is mechanical, electrical, hydraulic or pneumatic; the manner in which the power supplied to the device is converted to the energy of vibration, in particular the employment of electromagnetic, electrodynamic, magneto-restrictive or piezoelectric conversion; the spectral composition of the induced vibrations, in particular whether the induced vibrations are harmonic (sinusoidal), bi-harmonic or poly-harmonic vibrations; and the employment of impacts, in particular whether the device in a non-percussive or vibration-percussive. For example, a suitable vibration imparting device may be mechanical and impart a harmonic (sinusoidal) vibration. For completeness, vibration imparting devices of the present disclosure may be provided with a cooling mechanism—such as forced water cooling—to mitigate the effects of any high temperatures to which the devices are exposed.

As used herein “channel” means a course, pathway or conduit having an inlet and an outlet and which can contain a volume of fluid. The channel may be open or closed and may have an interior cross-sectional shape selected from U-shaped, semi-circular, V-shaped, rectangular, square, elliptical, oblate circular, round, octagonal, heptagonal, hexagonal, pentagonal and triagonal.

The term “ladle” refers to a vessel which is used for transferring a molten material. Ladles may be characterized by a maximum volumetric capacity.

The term “launder” as used herein is an open or closed component connected directly to a heater—such as furnace, oven or induction heater—into which molten material is released therefrom. The angle of entry from the heater to the launder and the internal cross-sectional profile of the lauder may be moderated to determine the degree of turbulence in a flow of molten material.

The term “controller” refers to dedicated hardware elements which are capable of executing software. The controller may, for example, include as hardware elements one or more of: digital signal processor (DSP) hardware; a network processor; application specific integrated circuit (ASIC); field programmable gate array (FPGA); read only memory (ROM) for storing software; random access memory (RAM); non-volatile storage; or, logic.

Where components herein, such as a heater or conveyancing apparatus, are in communication with a controller, the components may be able to receive executable instructions from the controller and execute those instructions; some examples of instructions are software, program code and firmware. The controller may be included as part of the component may be separate. Where physically separate, the controller may have a wired or wireless connection to the component.

As used herein, the term “melting temperature”, or “melting point” refers to the temperature at which a material exhibits peak unit heat absorption per degree Celsius, as determined by Differential Scanning Calorimetry (DSC). Above its melting temperature, the material can exhibit liquid properties and can move, for example, flow or diffuse.

As used herein, the “liquidus temperature” (T_{liq}) is the lowest temperature at which a material is completely liquid and the maximum temperature at which crystals can co-exist with the melt in thermodynamic equilibrium. The liquidus temperature is conventionally determined by the thermal analysis of the material's cooling cycle and observing the arrest in the time-temperature curve which is indicative of the commencement of crystallization.

Viscosities of the materials described herein are, unless otherwise stipulated, measured using the Anton Paar Viscometer, Model MCR 301 at standard conditions of 25° C. and 50% Relative Humidity (RH). The viscometer is calibrated at least one time per year. The calibration is done with using liquids of known viscosity, which vary from 1 cps to 50,000 cps (parallel plate PP25 and at shear rate 1 s⁻¹ at 23° C.). Measurements of the materials according to the present disclosure are performed using the parallel plate PP20 at different shear rates from 1.5 to 100 s⁻¹.

“Specific volume” is a property of materials, defined as the number of cubic meters occupied by one kilogram of a particular substance. The standard unit is the meter cubed per kilogram (m³/kg or m³·kg⁻¹).

Where mentioned, the “void content” of a tubular membrane, hollow fiber membrane or capillary membrane is determined in the following manner. A bundle of dried filaments is cut to 5 cm in length and the weight thereof was measured. This bundle is dipped in water for 30 minutes and thereafter excess water adhering to the hollow portion and outer surface of the filaments is removed. Then, the weight of water permeating the fine pores is obtained and the weight converted into volume. Thus the volume ratio was obtained and the void content is calculated by the following equation:

Void content (%)=100*(Volume of water permeating the pores)/(Volume of the dried membrane)

The term “permeability” as used herein is intended to include gas permeability, vapor permeability and liquid permeability. With regard to the movement of substance X in a membrane, permeability may be quantified as a thickness- and partial pressure normalized permeability coefficient (Pₓ):

qₘₓ=Pₓ*A*Δpₓ*(1/δ)

wherein: qₘₓ is the volumetric flow rate of substance X through the membrane; A is the surface area of one major side of the membrane through which substance X flows, Δpₓ is the pressure difference of the partial pressure of substance X across the membrane, for instance the pressure difference at the retentate and permeate sides; and δ is the thickness of the membrane.

In cases where a membrane is surface treated, an experimentally measured value of permeability may not reflect the true bulk material property but is rather an effective permeability coefficient for the treated membrane sample. Permeability is measured at room temperature, unless otherwise indicated.

The term “total surface area” as used herein with respect to membranes refers to the total surface area of the side of the membrane exposed to the feed gas mixture.

The term “tensile strength” as used herein refers to the rupture stress per unit cross-sectional area of a filament subjected to a tensile test. The tensile strength is measured in accordance with ISO 527-1 Tensile Testing of Plastics using an Intelect II STD Tensile Tester, available from Thwing-Albert (USA). The tensile strength is measured at a cross-head speed of 1.25 cm per minute: any reported measured values are the average of at least five measurements.

The present materials may be defined herein as being “substantially free” of certain compounds, elements, ions or other like components. The term “substantially free” is intended to mean that the compound, element, ion or other like component is not deliberately added to the material and is present, at most, in only trace amounts which will have no (adverse) effect on the desired properties of the material. An exemplary trace amount is less than 1000 ppm by weight of the material. The term “substantially free” expressly encompasses the condition “free” and thereby those embodiments where the specified compound, element, ion, or other like component is completely absent from the material or is not present in any amount measurable by techniques generally used in the art.

### BRIEF DESCRIPTION OF THE DRAWINGS

FIG. 1 appended hereto represents a generalized structure of a housed membrane module as applicable to the present disclosure.

FIGS. 2A and 2B are representations of an exemplary and non-limiting embodiment of a spiral would membrane which may be disposed within the housing of FIG. 1, according to embodiments of the present disclosure.

FIG. 3 represents an exemplary and non-limiting embodiment of a hollow fiber filtration membrane module, according to embodiments of the present disclosure.

FIG. 4 is a lateral view of a bundle of hollow fiber membranes which have been cast at their ends, according to embodiments of the present disclosure.

FIG. 5 is an enlarged sectional view taken along line II-II of FIG. 4, according to embodiments of the present disclosure.

FIG. 6 is a flowchart of an example method of forming a header assembly for a hollow fiber membrane separation module, according to embodiments of the present disclosure.

FIG. 7 is a flowchart of an example method of making a spiral wound separation module, according to embodiments of the present disclosure.

### DETAILED DESCRIPTION

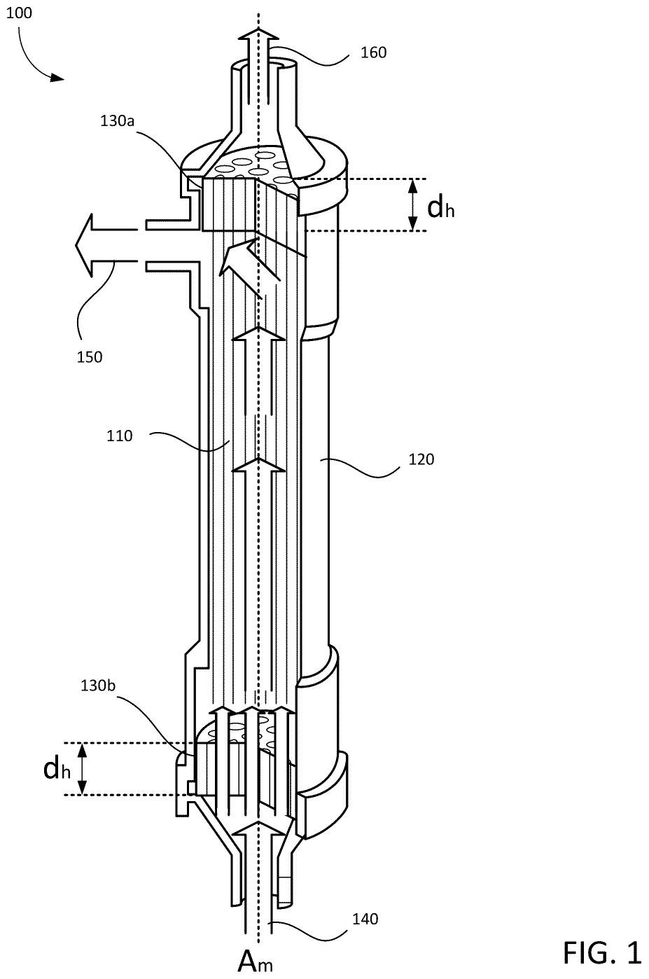

As shown in FIG. 1, a separation module 100 is provided with a housing 120 in which at least one membrane 110 is disposed and affixed at the headers 130a-b (generally or collectively, headers 130), which headers comprise or consist of the potting material described herein below. The provision of membranes 110 within a modular cartridge permits the membranes 110 to be facilely repaired or replaced during use.

The headers 130 are spaced apart within the housing 120 and are each defined by an axial length (dₕ) parallel to the axis (Aₘ) of the housed membranes 110. The dimensions of each header 130a-b may be independently selected, and may be the same or different. In some embodiments each header 130a-b may have the same axial length (dₕ).

The housed membranes 110 are primarily available as hollow fiber membranes, capillary fiber membranes, tubular membranes and flat sheet membranes provided in pleated, stacked or spiral wound configurations, as described herein below. The constituent membranes 110 of the module 100 may further be provided in composite, supported or integral forms: composite membranes comprise a very thin retentive layer attached to a preformed porous support; in a supported membrane, the actual membrane is attached to a strong sheet material of negligible retentivity; and integral type membranes are formed in one and the same operation having layers of the same composition.

Independently of the form of the membranes, however, it is preferred that the housed membrane(s) 110 should provide a total surface area for permeation of at least 10 m², for instance at least 100 m², at least 1000 m², at least 2000 m² or at least 2500 m². In providing a surface area for permeation, a multicomponent feed 140 is introduced into the module 100, and the retentate 150 and permeate 160 are withdrawn therefrom. Alternative feed, retentate and permeate withdrawal points are possible but are not illustrated in FIG. 1. However, all feed, concentrate, and filtrate piping connections are conventionally integral to the separation module 100.

The membrane or membranes 110 included in the module 100 may comprise polymers, inorganic compounds or a combination thereof. For example, in a composite membrane a thin, homogeneous retentive layer may be disposed on a porous inorganic support layer. Exemplary inorganic compounds include but are not limited to: silica; alumina; aluminosilicates, such as zeolites; titania; and zirconia oxide. Exemplary polymers include but are not limited to: polysilanes; organopolysiloxanes; cellulose esters such as cellulose acetate, cellulose butyrate and cellulose acetate butyrate; nitrocellulose; polysulfones; polyethersulfones; polyacrylonitriles; polyamides; polyimides; polyolefins, such as polyethylene or polypropylene; polytetrafluoroethylene (PTFE); polyvinylidene fluoride; and polyvinylchloride (PVC).

The housed membrane(s) 110 should be selectively permeable to one or more substances. In an embodiment, the membrane(s) 110 are selectively permeable to one gas over other gases or liquids. In another embodiment, the housed membrane(s) 110 are selectively permeable to more than one gas over other gases or liquids. In one embodiment, the membrane(s) 110 are selectively permeable to one liquid over other liquids or gases. In another embodiment, the membrane(s) 110 are selectively permeable to more than one liquid over other liquids. And in an embodiment, the membranes 110 are selectively permeable to water, carbon dioxide or methane over other gases or liquids.

The potting material of the header 130 must have a melting point which is lower than the failure temperature of the membrane 110, but higher than the operating temperature of the finished separation module 100. As described herein above, the potting material of the header 130 is a tin (Sn) alloy having a melting point of from 210 to 230° C. It is preferred for the potting material to be substantially lead-free.

Tin demonstrates an increase in its specific volume upon melting and a decrease thereof upon solidification. Consequently, upon cooling and solidification, tin melts can effectively penetrate small interspaces between tube, hollow fiber or capillary membranes 110 or penetrate into and between laminae of sheet membranes 110. However, the melting point of pure tin is 231.9° C. and is too high for many membrane separation applications. It is therefore desired to use a tin alloy whose melting point has been lowered through appropriate selection of alloying elements.

In some embodiments, the potting material consists of a tin alloy consisting of, on a metals basis: from 95 to 97 wt. % tin; and from 3 to 5 wt. % of the combination of silver (Ag) with at least one of Nickel (Ni), copper (Cu), or Germanium (Ge). Preferably each of Ni, Cu, and Ge are present in the tin alloy. Additionally or alternatively to that statement of preference, it is preferred that the ratio by weight, on a metals basis, of Ag to the total of Ni, Cu, and Ge in the tin alloy is from 3:1 to 6:1, for example from 3.5:1 to 5.5:1.

In other embodiments, the potting material consists of a tin alloy consisting of, on a metals basis: from 95.0 to 96.5 wt. % of Sn; and from 3.5 to 5.0 wt. % of the combination of Ag with at least one of Ni, Cu, or Ge.

In certain embodiments, the potting material is obtained by forming in the molten phase a mixture consisting of, based on the weight of the mixture: from 90 to 99 wt. % of a eutectic alloy having the designation Sn_{96.5}Ag_{3.5}; and from 1 to 10 wt. % of an alloy having the designation NiGeSn₉₉Ge₁. For example, the potting material may be obtained by forming in the molten phase a mixture consisting of, based on the weight of the mixture: from 95 to 99 wt. % of a eutectic alloy having the designation Sn_{96.5}Ag_{3.5}; and from 1 to 5 wt. % of an alloy having the designation NiGeSn₉₉Ge₁.

In other embodiments, the potting material is obtained by forming in the molten phase a mixture consisting of, based on the weight of the mixture: from 90 to 99 wt. % of an alloy having the designation Sn_{96.5}Ag_{3.5}; and from 1 to 10 wt. % of a eutectic alloy. For example, the potting material may be obtained by forming in the molten phase a mixture consisting of, based on the weight of the mixture: from 95 to 99 wt. % of a eutectic alloy having the designation Sn_{96.5}Ag_{3.5}; and from 1 to 5 wt. % of a cupric alloy.

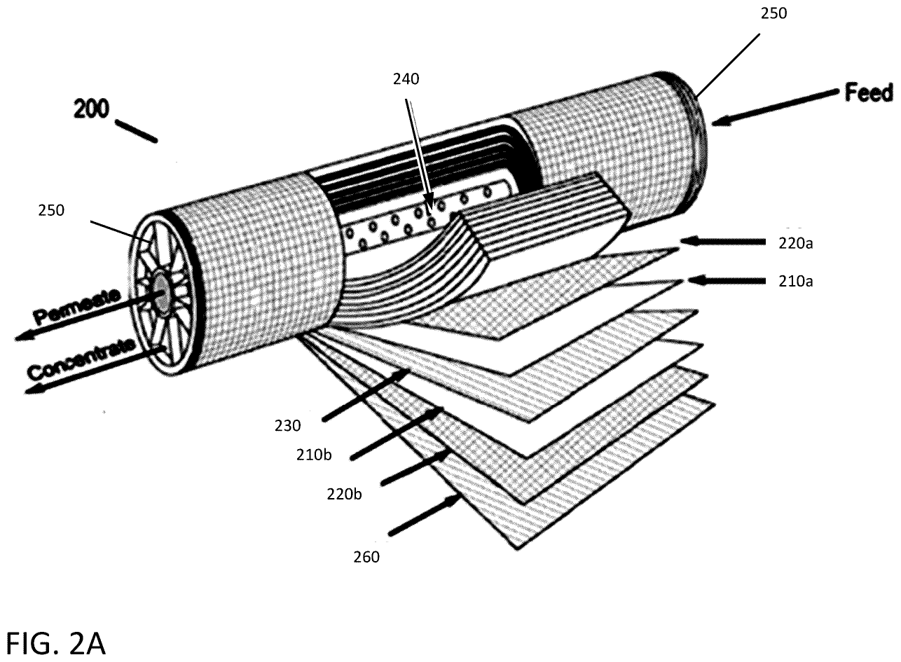

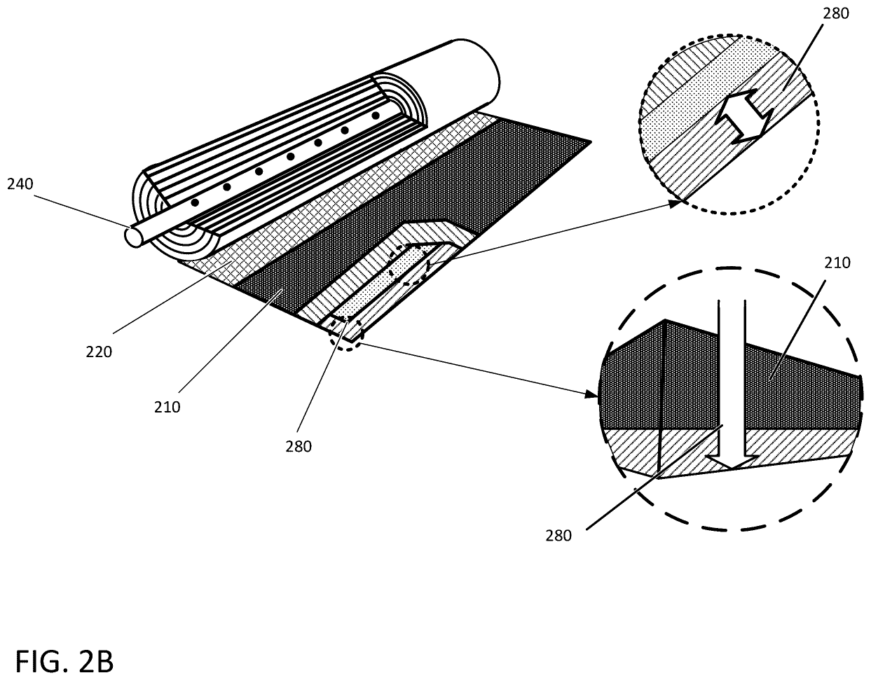

FIG. 2A shows a spiral wound membrane module 200 which may be disposed in separation module 100 and affixed using the potting material of the headers 130 depicted in FIG. 1. The primary component is the separation membrane 210, which is formed into a flat sheet and which conventionally comprises a lamina of backing material. Other significant internal components are a feed channel spacer 220, a permeate spacer 230 or permeate collection material, a permeate collection tube or center tube 240, and an end surface holder or anti-telescoping device 250 disposed at each end of the module 200. The membrane 210 is arranged to form an envelope around the permeate spacer 230: the term “membrane leaf” is used to define two membrane sheets 210 disposed back-to-back with a permeate spacer 230 disposed therebetween. The feed channel spacer 220 is placed over the envelope. The envelope and feed channel spacer 220 are wound around the center tube 240. Feed fluid can access the surface of the membrane 210 by flowing into the edge of and across the feed channel spacer 220, and the feed channel spacer 220 creates turbulence in the feed flow path. Permeate passes through the membrane 210, then flows through the permeate spacer 230 and center tube 240. Concentrate flows out of the downstream edge of the feed channel spacer 220 to leave the module 200. The anti-telescoping devices 250 are bonded to the center tube 240 and also held in place by an outer wrap 260. The anti-telescoping devices 250 prevent the envelopes from being pushed along the length of the center tube 240 by the feed fluid.

Whilst the membrane sheets 210 may be edge-sealed by heating, adhesives 280 may also be used for this purpose, as shown in FIG. 2B. Suitable adhesive compositions must have a closely controlled viscosity to moderate the penetration and horizontal spread of the composition shown in the inserts of FIG. 2B. Where the adhesive 280 has too low a viscosity, the adhesive 280 tends both to horizontally spread and to wick or rise up through the capillaries of the membrane 210 and where applicable, any support present, thereby creating voids and reducing the initial integrity of the membrane leaf: this can be particularly problematic for asymmetric membranes. Conversely, if the adhesive composition has too high a viscosity, there may be insufficient wicking and sharp interfacial transitions exist within the membrane leaf which can promote structural failure.

Spiral wound membranes of this structure-type are disclosed in the following citations: U.S. Pat. Nos. 4,235,723; 3,367,504; 3,504,796; 3,493,496; EP 0251620 A2; and U.S. Pat. No. 3,417,870.

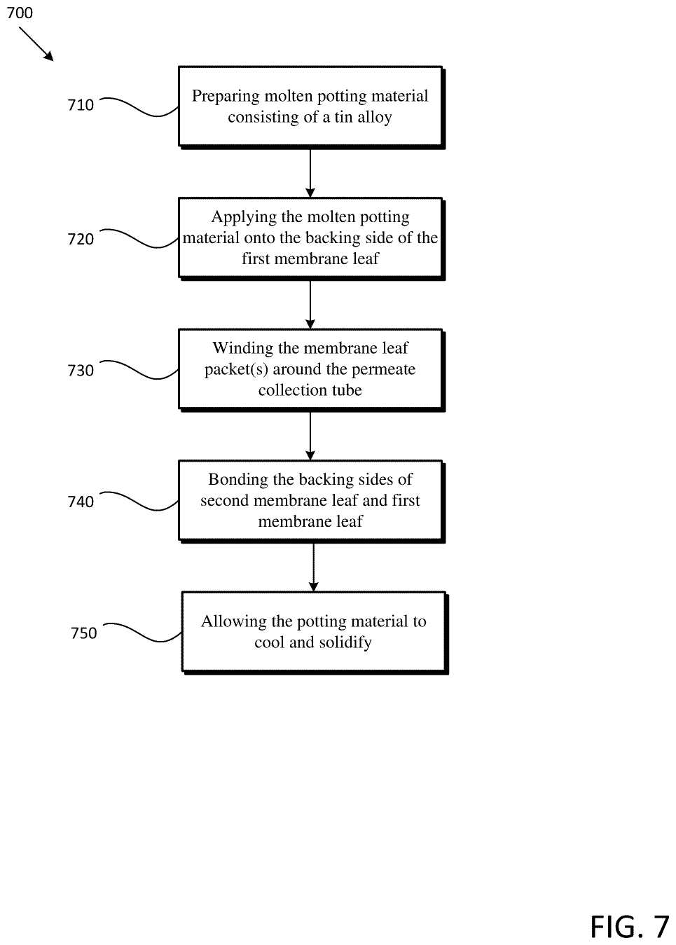

The present disclosure provides, with respect to FIG. 7, a method 700 of making a spiral wound separation module 200, the spiral wound separation module 200 comprising a permeate collection tube 240 and a plurality of membrane leaf packets wound about the collection tube 240, each membrane leaf packet having first and second membrane sheets 210 in between which is disposed a permeate spacer 230 and wherein each membrane sheet 210 has a membrane side and a backing side, the method 700 including: preparing (per block 710) a molten potting material consisting of a tin alloy having a melting point of from 210 to 230° C., wherein the tin alloy consists, on a metals basis, of: from 95 to 97 wt. % Sn; and from 3 to 5 wt. % of the combination of Ag with at least one of Ni, Cu, or Ge; applying (per block 720) the molten potting material at a temperature of from 225° C. to 275° C. onto at least a portion of the backing side of the first membrane leaf; winding (per block 730) the membrane leaf packet(s) around the permeate collection tube; and bonding (per block 740) the backing side of the second membrane leaf to the backing side of the first membrane leaf, for example by allowing (per block 750) the potting material to cool and solidify. Method 700 may iterate through various operations to continue bonding additional layers to form the separation module.

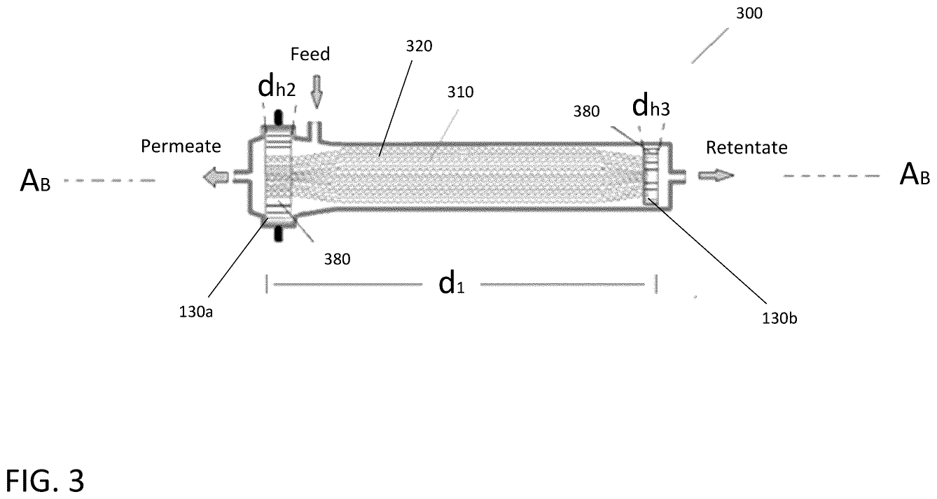

Hollow fiber membrane modules may be used in some embodiments of the present disclosure. FIG. 3 exemplifies a housing 300 enclosing a plurality of hollow fiber membranes 320, which are bundled together longitudinally to form a bundle 310 having a core axis (A_{B}) and defining a first axial length (d₁). The bundle 310 of hollow fiber membranes 320 is disposed within the housing 300, and is affixed using headers 130a-b comprising or consisting of the potting material 380 as described herein.

More particularly, there is provided a first header 130a disposed within the housing 300, the first header 130a comprising a potting material 380 which is provided as a cast having a second axial length (dₕ₂), wherein the ratio of the first axial length (d₁) to the second axial length (dₕ₂) is from 1:10 to 1:100 or 1:5 to 1:50. A second header 130b is disposed within the housing in a spaced apart relationship from the first header 130a, the second header 130b comprising a potting material 380 which is provided as a cast having a third axial length (dₕ₃), wherein the ratio of the first axial length (d₁) to the third axial length (dₕ₃) is from 1:10 to 1:100 or 1:5 to 1:50. The potting material 380 of the first header 130a encases a first end of the bundle 310 over the second axial length (dₕ₂); the potting material 380 of the second header 130b encases a second end of the bundle over the third axial length (dₕ₃). The potting material 380 consists of a tin alloy having a melting point of from 210 to 230° C. (or 215 to 220° C.), wherein the tin alloy consists, on a metals basis, of: from 95 to 97 wt. % Sn; and from 3 to 5 wt. % of the combination of Ag with at least one of Ni, Cu, or Ge.

The hollow fiber membranes 320 of the bundle 310 have been depicted in FIG. 3 as being crimped but this is for illustration only. Further, the fiber membranes 320 of the bundle 310 may either be bundled together in straight form, may be interwoven or may be chaotically bundled. As will be understood, the act of chaotically bundling describes gathering a set of elements into a bundle with no discernable or repeated pattern of the elements within the bundle (e.g., to produce a bundle that is chaotically gathered and arranged).

Moreover, in addition to the potting material 380, the bundle 310 may be restrained by further devices along the length of the bundle 310. Such devices may include one or more transverse filaments and/or may include one or more bands which are disposed around the circumference of the bundle 310. Exemplary filtration modules based on hollow fiber membranes constructed using potting compositions which may have utility in the present disclosure are described in, for example: U.S. Pat. Nos. 8,758,621; 8,518,256; 7,931,463; 7,022,231; 7,005,100; 6,974,554; 6,648,945; 6,290,756; and US2006/0150373.

The bundle 310 of FIG. 3 comprises a plurality of hollow fiber membranes 320. For example, the bundle 310 may comprise from 5 to 50000 hollow fiber membranes. In some embodiments, the bundle may have from 1000 to 10000, from 2000 to 8000 or from 3000 to 6000 hollow fiber membranes. The total number of hollow fiber membranes may be selected to meet the aforementioned preferred total surface membrane area.

In a hollow fiber membrane 320, each fiber has a bore side and a shell side. Collectively, the bore side and the shell side of the fibers may be accessible through a single connector on each side of the module. Alternatively, the hollow fiber membranes 320 may have a bore side and a shell side accessible through multiple connectors disposed at various points in the module 100. Whether one or more feed into the module 300 contacts the shell side or the bore side of the hollow fiber membrane 320 may be independently selected for each feed. Further, where more than one feed is introduced into the module 300, the relative flow pattern of the feeds may be cross-current, counter-current, co-current or a combination thereof; flow relationships may thereby occur in a linear or radial pattern within the module 100.

The hollow fiber membranes 320 are preferably characterized by at least one of following parameters:
i) An outer diameter of from 20 to 2000 microns, for example from 200 to 1000 microns;
ii) A thickness (t), as defined by the equation Thickness=0.5*(Outer Diameter−Inner Diameter), of from 0.1 to 100 microns, for example from 0.1 to 50 microns or from 0.1 to 20 microns; and
iii) A tensile strength of at least 25 MPa, for example from 25 to 100 MPa or from 25 to 75 MPa.

These characterizations are not mutually exclusive and one, two or three of them may be applied. With particular regard to the thickness of the hollow fiber membranes 320, where the thickness of the wall of the hollow fiber membrane is below 0.1 microns, the pressure resistance thereof may be insufficient. If the thickness of the hollow fiber is greater than 200 microns, the selective permeability of the hollow fiber membrane 320 to water vapor may be diminished.

The shell of the hollow fiber membranes 320 provided to the bundle 310 may, in some embodiments, comprise a multiplicity of pores. The term “pore” as used herein is not limited to through pores and thus does not necessarily mean that the pores penetrate from one major side of the shell to the other major side. Rather the term also encompasses blind or saccate pores and closed pores. Porous hollow fiber membranes 320, independently of or additional to the above characterizations of diameter, thickness and tensile strength, may therefore be characterized by both their overall pore density and by the density of the individual pore types. For examples the porous hollow fiber membranes may be characterized by one or more of the following parameters:
a) A void content of from 50 to 90%, for example from 60 to 90%;
b) A total number of pores of from 1×10⁹ to 1×10¹², for example from 1,000,000,000 to 1,000,000,000,000 per mm length of fiber;
c) A total number of saccate pores of from 0 to 1×10¹², for example from 0 to 500 per mm length of fiber;
d) A total number of through pores of from 0 to 20,000, for example from 0 to 50 per mm length of fiber.

These characterizations are again not mutually exclusive and one, two, three or four of them may be applied. The pore structure of the fibers can be determined by conventional examination methods, including by scanning electron micrography (SEM) or transmission electron micrography (TEM) at a magnification of at least 400:1.

In an embodiment, the hollow fiber membranes 320 of the bundle 310 are characterized by having from 0 to 20, from 0 to 10, or from 0 to 5 per mm length of fiber of through-pores having a diameter greater than 0.1 m. Pore diameter of the through-pores is determined herein at the surface of the hollow fiber using SEM or TEM.

### Illustrative Hollow Fiber Membrane Module

In some illustrative embodiments, there is provided a module (300) comprising a housing in which a bundle (31) of hollow fiber membranes (32) is disposed in a fixed positional relationship by the potting material (38), wherein: the bundle (31) comprises from 1000 to 10000 hollow fiber membranes (32); and the hollow fiber membranes have an outer diameter of from 200 to 1000 microns, a membrane thickness of from 0.1 to 20 microns and a tensile strength of from 25 to 75 MPa, further wherein the hollow fiber membranes (31) comprise or consist of a polyimide having a selective permeability for water vapor relative to C₁ to C₄ alkanols. The hollow fiber membranes may, for example, be characterized by a selective permeability (P[H₂O]/P[C₁-C₄ alkanol]) at 125° C. of at least 20.

In other illustrative embodiments, there is provided a module (300) comprising a housing in which a bundle (31) of hollow fiber membranes (32) is disposed in a fixed positional relationship by the potting material (38): the bundle (31) comprises from 1000 to 10000 hollow fiber membranes (42); the hollow fiber membranes have an outer diameter of from 200 to 1000 microns, a membrane thickness of from 0.1 to 20 microns and a tensile strength of from 25 to 75 MPa, further wherein the hollow fiber membranes (31) comprise or consist of a polyimide having a selective permeability for water vapor relative to ethanol (C₂H₅OH). The hollow fiber membranes (31) may, for example, be characterized by a selective permeability (P[H₂O]/P[C₂H₅OH] at 125° C. of at least 20.

The polyimide may be an aromatic polyimide obtainable by polymerizing: a polycarboxylic acid or a polyanhydride, ester or salt thereof; and an aromatic diamine. Exemplary polycarboxylic acids include: 3,3′,4,4′-benzophenonetetracarboxylic acid; 2,3,3′,4′-benzophenonetetracarboxylic acid; pyromellitic acid; 3,3′,4,4′-biphenyltetracarboxylic acid; 2,3,3′,4′-biphenyltetracarboxylic acid; and dianhydrides, esters or salts of these acids. Exemplary aromatic diamines include: p-phenylenediamine; m-phenylenediamine; 2,4-diaminotoluene; 3,5-diaminobenzoic acid; 3,4′-diaminodiphenyl ether; 4,4′-diamino diphenyl ether; 4,4′-diaminodiphenyl methane; o-tolidine; 1,4-bis(4-aminophenoxy)benzene; 1,3-bis(4-aminophenoxy)benzene; o-tolidinesulfone; bis(aminophenoxyphenyl)methane; and bis(aminophenoxyphenyl)sulfone.

### Methods and Applications

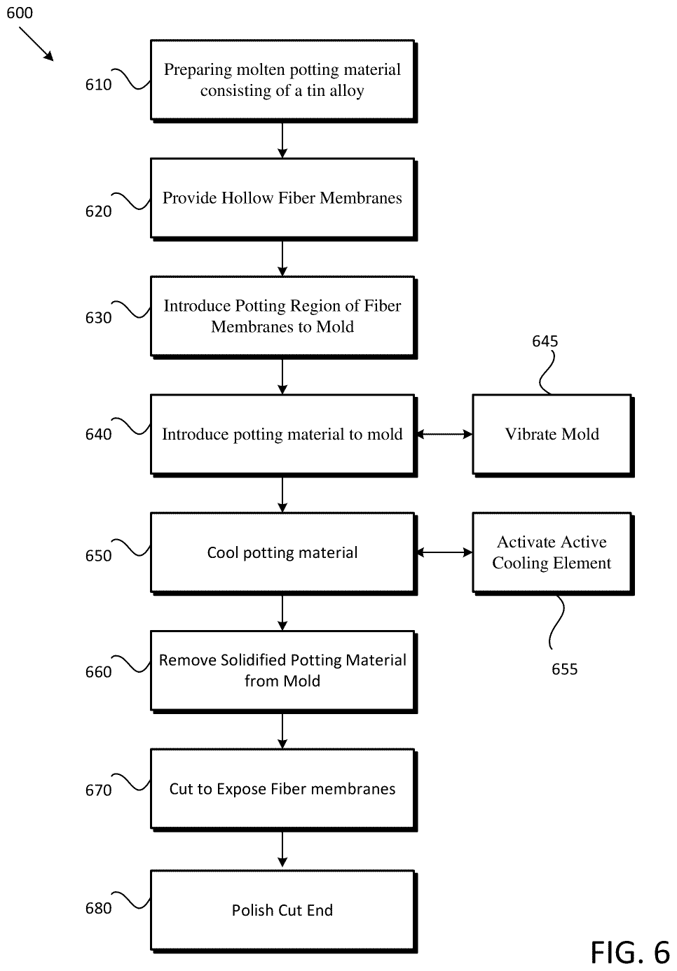

FIG. 6 is a flowchart of a method 600 of forming a header assembly for a hollow fiber membrane separation module, according to embodiments of the present disclosure. Method comprising begins at block 610 with preparing a molten potting material consisting of a tin alloy having a melting point of from 210 to 230° C., wherein the tin alloy consists, on a metals basis, of: from 95 to 97 wt. % Sn; and from 3 to 5 wt. % of the combination of Ag with at least one of Ni, Cu or G. At block 620, an operator provides a plurality of hollow fiber membranes having a potting region. At block 630, the operator introduces the potting region of the plurality of membranes into the cavity of a mold having a volumetric capacity. At block 640, the operator introduces the molten potting material into the cavity of the mold at a temperature of from 100° C. to 250° C. such that the potting material flows around the membranes. At block 650, the operator allows the potting material to cool; thereby solidifying the potting material in the cavity of the mold. At block 660, the operator removes the solidified potting material from the mold. At block 670, the operator cuts a portion of the solidified potting material so that the ends of the plurality of hollow fiber membranes are exposed.

In various embodiments, block 620 may include providing a bundle of hollow fiber membranes. That bundle may, in some embodiments, be substantially retained within a cylindrical cage to stabilize the bundle and to support the fibers along their length, with the potting region of the bundle extending from an end of the cage.

The molten potting material of the present disclosure is formed by melting and mixing the respective elements. When brought together, the temperature of the mixture of elements may be raised using conventional means, such as: convection ovens; vacuum melting furnace; resistance heating rods; and arc melters. In some embodiments, the molten potting material is prepared by inductive heating of the alloy: the maximum power output of the inductive heater may be selected to ensure that the elements melt without the induced surface currents causing sparking. Independently of the melting method employed, heating may be conducted under an inert gas atmosphere: suitable inert gases which may be mentioned include nitrogen, helium, and argon. Precaution should be used when common nitrogen gases are used as a blanket, because such nitrogen may not be dry enough on account of its susceptibility to moisture entrainment; the nitrogen may require an additional drying step before use herein.

The system employed for the application of the potting material to the membrane or membranes may, in some embodiments, include a conveyance assembly comprising one or more channels, the assembly providing fluid communication of the molten potting material between the apparatus used for melting that material and the mold. The conveyance of the molten potting material along the aforementioned assembly may be conducted under gravitational flow. Alternatively or additionally, the apparatus may be further provided with a pump—such as an electromagnetic pump or mechanical pump—to drive the conveyance of the molten potting material.

The conveyancing apparatus may optionally include further components conventional in the field of metallurgy. Such exemplary components include but are not limited to: a ladle; a launder; a pour basin; and a nozzle. These components may be structurally integrated into the melting apparatus or into the constituent channels of the conveyancing apparatus or may, alternatively, be provided as discrete, physically separable components.

In certain embodiments the molten potting material will be applied per block 640 by either static potting or centrifugal potting of membranes in the dedicated mold. In a static potting technique, the molten potting material is introduced into a membrane potting mold while the mold is substantially stationary. In centrifugal potting methods, the molten potting material is introduced into a membrane potting mold while the mold is being rotated such that the rotation of the mold forces the potting material towards an end of the rotating mold by centrifugal force. In either the static or centrifugal potting methods, the introduction of the molten potting material into the potting mold may be either through a contact or non-contact methodology. As an exemplary contact methodology, mention may be made of funneling. As exemplary non-contact methodologies, there may be mentioned jetting, omega coating, control seam coating and slot spray coating. The introduction of the molten potting material under pressure is not required but should a pressurized application be elected, suitable pressures may be from 1.5 to 20 bars, for example from 2 to 10 bars.

The employment of a static molding process as described does not preclude the application of vibration to the potting material whilst it is in the molten state, such as in optional block 645. As such, the potting apparatus may include at least one vibration imparting device. In an illustrative embodiment, the apparatus employed for the application of the potting material to the membrane includes: a heater for melting the potting material; a mold configured to receive the potting portion of the membrane; and a conveyance assembly comprising one or more channels, the assembly providing fluid communication of the molten potting material between the heater and the mold, wherein the apparatus is characterized in that it further comprises at least one vibration imparting device.

The vibration imparting device should not be disposed in the internal volume of the mold or, more particularly, within the molten potting material itself. Typically, the vibration imparting device will directly contact an outside surface of the mold or, alternatively, be disposed sufficiently proximate to an outside surface of the mold to ensure the efficacy of the generated vibrations relative to the molten potting material disposed therein. In an exemplary embodiment, a vibration table is provided which comprises a static base and an oscillatory planar top on which the mold is disposed during the potting operation. The oscillations may occur along one or more axis—for instance along the major vertical (y) and/or horizontal (x) axes. Moreover, the vibration table may adapted to tilt the plane on which the mold is disposed. Illustrative vibration tables which may have utility in the present disclosure are described in: U.S. Pat. No. 4,483,621 (Kreiskorte); U.S. Pat. No. 7,802,355 (Spangenberg); and US2020/0149990 (Nie et al.).

The vibration of the potting material in the mold serves to reduce the porosity and the grain size of the potting material as it solidifies in the mold. The molten material may contain gas—which has become entrained therein during the heating and conveyance of the material—and the applied vibration has a degassing effect, which can negate or reduce the need to include degassing agents in the potting material. Further, vibration may promote nucleation of the molten potting material in the mold and the formation of non-dendritic or non-acicular grains.

In some embodiments, the or each vibration imparting device should impart to the mold a vibration having at least one of the following characteristics:
i) a frequency of from 20 kHz to 1 MHz, for example a frequency of from 20 to 100 kHz; and
ii) a power density of from 10 W/cm³ to 10 MW/cm³, for example from 10 to 10000 W/cm³ or from 10 to 1000 W/cm³, based on the volumetric capacity of the mold.

The duration for which the vibration is imparted to the molten potting material in the potting mold will be dependent upon the composition and volume of the material being processed. An exemplary duration is from 0.01 to 100 seconds, for example from 1 to 50 seconds. However, once the beneficial results of the vibrational processing have been achieved whilst the potting material is in the molten phase, continued subjection of the potting material to vibration as it cools is not considered deleterious.

The aforementioned conveyance assembly may itself be provided with at least one vibration imparting device. Where more than one vibration imparting device is provided to the conveyancing apparatus, the devices may in some embodiments be spaced at regular intervals along the length of the constituent channel(s).

As the molten material should not be solidifying as it is conveyed to the mold, it is not precluded that a vibration imparting device—such an ultrasonic radiator—provided to the conveyancing apparatus may be inserted into the molten material. However, a device used in this manner will be required at least: to have a high mechanical strength and erosion resistance at high temperature; to have a resistance to thermal shock; and to be unreactive with the molten alloy. More conventionally, the further vibration imparting device(s) may be disposed at an outside surface of the channels or of those further components of the conveyancing means through which the molten potting material passes. As described above, the disposition of vibration imparting device at a locus along which the molten material passes means that the device may be disposed directly on an outside surface of the channel or component or alternatively be disposed sufficiently proximate to an outside surface of the channel or component to ensure the efficacy of the generated vibrations relative to the molten potting material disposed therein.

In some embodiments, the apparatus may further be provided with a controller having utility in the automation of the melting and conveyance of the molten potting material to the potting mold and where applicable, the imparting of vibration to the mold and/or the conveyancing apparatus.

The above aside, central to any method of application is that the potting material is sufficiently fluid upon introduction into the mold for it to penetrate the desired layers of laminae (flat sheets) or fibrous bundles and then solidify to seal the outer surfaces of the laminae or the fibers in the bundle to form a fluid tight seal. Upon introduction into the mold, the potting material may be characterized by a melt viscosity at 225° C. of less than 1000 mPa·s or even less than less than 100 mPa·s. Further, useful introduction temperatures will typically range from 225° C. to 275° C. or from 230° C. to 260° C. Where applicable, the temperature of the molten potting material may be raised from its initial or formation temperature to its introduction temperature using conventional means, such as: convection ovens; vacuum melting furnace; resistance heating rods; and arc melters.

Where the molten potting material introduced into the mold is to be subjected to vibration prior to its solidification, the mold itself may be provided with a heater to maintain the temperature of the potting material above its liquidus temperature. Such a heater may be constituted by inductive heating elements in some embodiments.

When the cooling of the molten potting material is initiated in the mold, the cooling rate of the potting material may be controlled to inhibit the formation of an Ag₃Sn crystalline phase—which is characterized by a plate-like morphology—as the potting material solidifies. The crystalline Ag₃Sn phase is easily nucleated and forms with minimal cooling just below the liquidus temperature of the potting material. Conversely the crystallization of the bulk Sn phase requires more significant undercooling below the liquidus temperature, for example to a temperature from 15 to 25° C. below the liquidus temperature. The crystalline Ag₃Sn plates grow in the time period of undercooling which proceeds the crystallization of the bulk Sn liquid phase: large plate-like crystals within the fully solidified potting material can be deleterious to the thermomechanical fatigue properties of the material. Given this, in some embodiments, a cooling rate of from 0.5 to 5° C.·s⁻¹, for example from 1 to 5° C.·s⁻¹ may be applied to the potting material within the mold.

To effect this cooling rate, the mold may be provided with a one or more cooling channels which are disposed within the body of the mold proximate to the cavity thereof and in which a fluid such as water is circulated. Alternatively or additionally, the mold may be air-cooled using a blower or compressed air: a flow of air over the surface of the cooling material may also serve to disperse gas released from the solidifying potting material. Active cooling elements may be activated/deactivated per optional block 655, or the potting material may be allowed to cool via heat exchange with the ambient environment.

The potting material may be allowed to solidify and then cool to room temperature within the mold. In some embodiments however, particularly where the mold is to be used in a further potting step, the potting material is permitted to first solidify and cool within the mold to a temperature of from 100 to 150° C.; the solidified potting material is then withdrawn from the mold and permitted to further cool externally. The withdrawn, solidified potting material—in which the fiber bundle is embedded at its potting region—will substantially possess the shape and volume of the mold in which it is formed. That volume may be further processed to form the header 130, the further processing including: a cutting operation at block 670 by which the cores (or lumens) of the hollow fiber membranes are exposed; and optionally, a polishing operation at block 680 by which the cut section, having the exposed fiber cores, is polished. The cutting operation is preferably performed in a transverse manner with respect to the longitudinal axis of the bundle 310. The cutting operation forms the header 130 having a pre-determined axial length (dₕ).

The potting process by which the header assembly is formed may then be repeated for a second region, more particularly a second end, of the bundled fibers. The bundle, having a first header 130a and optionally being supported within a cage, is rotated and the second potting region introduced into a mold in the manner described to form a second header 130b. The mold used may be the same as that for the first potting process. Alternatively, a second mold may be employed which differs in one or both of its shape and volumetric capacity from the first mold.

The pre-treatment of the membranes, for example of the hollow fibers or of laminae, prior to their potting is certainly not precluded. It can, for instance, be advantageous to treat these bodies with a removable wetting agent that is compatible with both the membrane and the applied molten material. Such wetting agents can insure the pot is reproducible and can eliminate issues of meniscus formation and the blocking of otherwise active pores of the membranes upon application of the potting material. Reference in regard to such pre-treatment may be made inter alia to: U.S. Pat. No. 4,389,363 (Molthop).

In other embodiments, the at least one membrane provided to the potting mold may have an adhesive material applied thereon: this adhesive material may in step b) provide some adhesion of the membranes to the cavity of the mold, effectively forming a substantially closed cavity surrounding the potting region. The application of layer of adhesive to hollow fiber membranes which are to be affixed in a membrane module using a liquid potting material is disclosed in: EP 2 012 908 A1 (Zenon Environmental Inc.); and EP 1 812 148 A1 (Zenon Environmental Inc.).

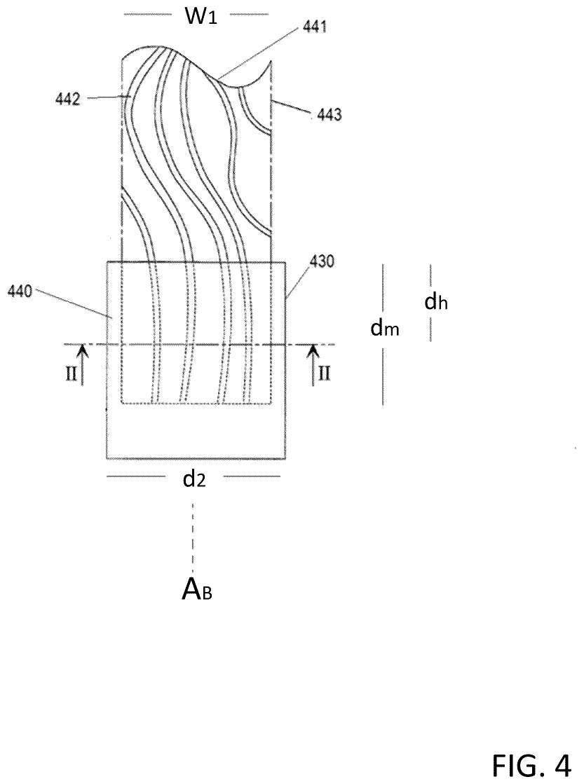

To provide an illustration of the performance of the above described method, FIG. 4 shows a bundle 441 comprising a plurality of hollow fiber membranes 442 shown from the side. The fiber membranes 442 are chaotically bundled and are touching one another. The outside contour of the bundle 441 is therefore merely indicated by a dash-dot enveloping curve 443. It is nevertheless possible to form a metallic header 430, which holds the individual fiber membranes 442 at one end among one another and with respect to a housing (FIG. 1) and does so reliably and with a seal.

The potting material of the type described herein before is melted and introduced into a mold 440 of suitable shape into which the potting region of the bundle 441 has previously been introduced. The bundle 441 thus becomes immersed into the melt at one end and the potting material impregnates the ends of the bundle. The axial depth (dm) of the mold is typically greater than its diameter (d₂) and may, in some embodiments be greater than the width (w₁) of the enveloping curve 443. Conventionally, the degree of penetration of potting material into the bores of the hollow fiber membranes 442 at both ends thereof is substantially less than the level of potting material permeating the bundle 441 outside of the bores, because the air inside of the bores is compressed as the potting material advances into the bores from both ends, causing a counter-pressure which inhibits the advance of potting material into the bores. As the result of this, after the potting material has solidified in the mold and the potted region has been withdrawn from the mold, one can cut transversely through the middle of the potting material towards the ends of each bundle 441—such as along line II-II—to expose open bores and to form the head plate 430 of an operable filtration membrane. Such cutting may, in certain embodiments, be performed using a water jet.

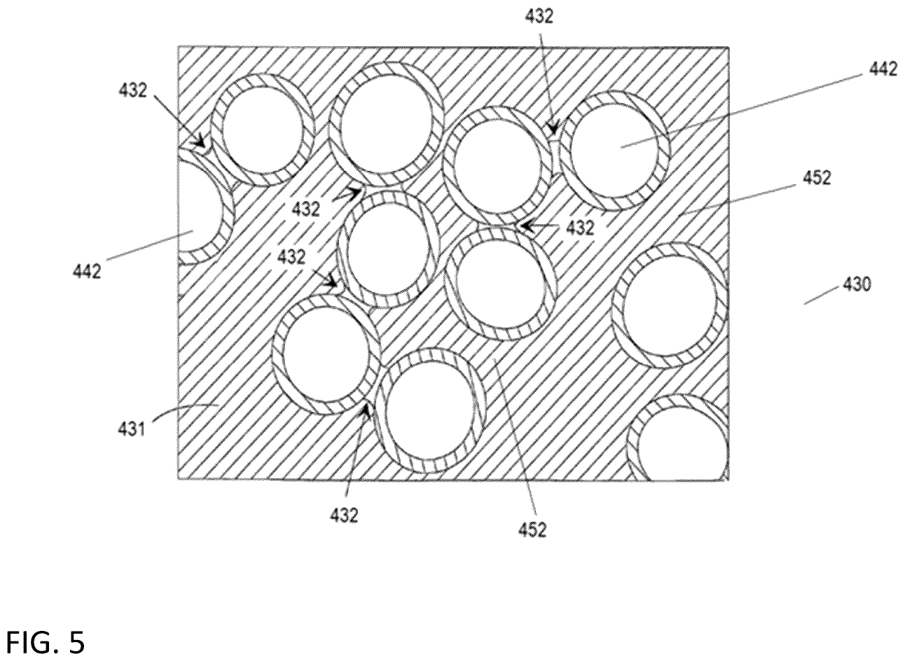

The lateral radial surface 431 obtained after cutting may be treated by machined to further open the bores of the fiber membranes and/or to polish the surface of the solid potting material. FIG. 5 shows a section of such a cut, which has been subsequently polished, on an enlarged scale. Larger interspaces 452 between the individual fiber membranes 442 are homogeneously sealed by the potting material with extremely fine pores and homogeneously in this enlarged diagram. If fiber membranes 442 are extremely close to one another, or are in contact, there remains a slight space 432 between the fiber membranes 442. However, these spaces are reliably sealed over the axial length (dm) of the mold 440 and/or the axial length (dₕ) the header 430 obtained after the aforementioned cutting.

After the aforementioned of the lateral radial surface 431 of the head plate 430, the fiber bundle 441 is then gripped with a seal and held at one end for a further application, including but not limited to disposal within the housing of a filtration module.

### Example

The following materials were employed in the Examples:

### Membrane:

LINQALLOY Sn_{96.5}Ag_{3.5}: Eutectic lead-free tin alloy having a eutectic melting temperature of 221° C., available from Caplinq Corporation.
Sn99Ge1: Lead free desoxidation concentrate, available from Felder Lottechnik (DE).

A chaotic bundle comprising 5000 hollow fibers membranes 320 was provided and held in a vertical position using clamps. The bundle had an average width (w₁) along its length of 55 mm. Elastic rings were provided at regular intervals along the length of the membrane: the regions of the membranes disposed between the individual elastic rings possessed a degree of curvature, such as illustrated in FIG. 4.

Using an induction heating system having a power output of 2 kW, 1.98 kg of the LINQALLOY Sn_{96.5}Ag_{3.5} and 0.02 kg of Sn99Ge1 were combined and heated together in an alumina graphite induction crucible for a duration of 15 minutes to form a melt having a temperature of 240° C. The molten alloy was poured into a cylindrical mold having a diameter of 60 mm and a depth of 10 cm and into which one end of the bundle had previously been introduced. The mold was placed on a vibration table which was operated at a frequency of 2 to 100 Hertz (Hz) and a power output of 10 to 2000 Watts per cubic centimeter (W/cm³) whilst the internal temperature of the mold was maintained at 240° C. The imparted vibration was maintained for a duration of 60 seconds after which the temperature of the mold was reduced to 150° C. at a cooling rate of 1° C./s, thereby permitting the alloy to solidify. The potted end of the bundle was then withdrawn from the end and permitted to cool to room temperature.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. Also, it should be appreciated that the features of the dependent claims may be embodied in the systems, methods, and apparatus of each of the independent claims.

Many modifications to and other embodiments of the invention set forth herein will come to mind to one skilled in the art to which these inventions pertain, once having the benefit of the teachings in the foregoing descriptions and associated drawings. Therefore, it is understood that the inventions are not limited to the specific embodiments disclosed, and that modifications and other embodiments are intended to be included within the scope of the appended claims. Although specific terms are employed herein, they are used in a generic and descriptive sense only and not for purpose of limitation.

We claim:

1. An alloy adapted for use in a membrane separation module for withdrawing permeate from a multicomponent fluid feed of a membrane potting material having a melting point of from 210 to 230 degrees Celsius (° C.), wherein the alloy consists, on a metals basis, of:
from 95 to 97 wt. % tin (Sn); and
from 3 to 5 wt. % of a combination of Silver (Ag) with at least one of Nickel (Ni), Copper (Cu), or Germanium (Ge).

2. A header assembly for a housed membrane separation module, the header assembly comprising:
a plurality of hollow fiber membranes which are bundled together longitudinally to form a bundle having a core axis and defining a first axial length; and
a potting material provided as a cast having a second axial length parallel to the core axis of the bundle, wherein a ratio of the second axial length to the first axial length is from 1:5 to 1:50;
wherein the potting material encases the bundle with a seal over the second axial length; and
further wherein the potting material consists of a tin alloy having a melting point of from 210 to 230° C., wherein the tin alloy consists, on a metals basis, of:
from 95 to 97 wt. % tin (Sn); and
from 3 to 5 wt. % of a combination of Silver (Ag) with at least one of Nickel (Ni), Copper (Cu), or Germanium (Ge).

3. The header assembly according to claim 2, wherein the tin alloy consists, on the metals basis, of:
from 95.0 to 96.5 wt. % of Sn; and
from 3.5 to 5.0 wt. % of the combination of Ag with at least one of Ni, Cu, or Ge.

4. The header assembly according to claim 2, wherein each of Ni, Cu, and Ge is present in the tin alloy and further wherein the ratio by weight, on the metals basis, of Ag to a total of Ni, Cu, and Ge is from 3:1 to 6:1.

5. The header assembly according to claim 2, wherein the plurality of membranes consists of a bundle of from 5 to 50000 hollow fiber membranes which are bundled together longitudinally.

6. The header assembly according to claim 5, wherein the bundle consists of from 1000 to 10000 hollow fiber membranes which are bundled together longitudinally.

7. The header assembly according to claim 5, wherein the hollow fiber membranes of the bundle are characterized by:
an outer diameter of from 20 to 2000 microns;
a membrane thickness (t) of from 0.1 to 100 microns; and
a tensile strength of from 25 to 100 Megapascals (MPa).

8. The header assembly according to claim 5, wherein the hollow fiber membranes of the bundle are porous and are further characterized by at least one of:
a void content of from 50 to 90%;
a total number of pores of from 1×10⁹ to 1×10¹²;
a total number of saccate pores of from 0 to 1×10¹²; and
a total number of through pores of from 0 to 20,000 per millimeter (mm) length of fiber.

9. A method of forming a header assembly for a hollow fiber membrane separation module, said method comprising:
preparing a molten potting material consisting of a tin alloy, wherein the tin alloy consists, on a metals basis, of: from 95 to 97 wt. % Tin (Sn), and from 3 to 5 wt. % of a combination of Silver (Ag) with at least one of Nickel (Ni), Copper (Cu), or Germanium (Ge);
providing a plurality of hollow fiber membranes having a potting region;
introducing the potting region of the plurality of membranes into a cavity of a mold having a volumetric capacity;
introducing the molten potting material into the cavity of the mold at a temperature of from 225° C. to 250° C. such that the potting material flows around the membranes;
solidifying the potting material in the cavity of the mold;
removing the solidified potting material from the mold; and
cutting a portion of the solidified potting material so that ends of the plurality of hollow fiber membranes are exposed.

10. The method according to claim 9, wherein the plurality of hollow fiber membranes consists of a bundle of from 5 to 50000 hollow fiber membranes which are bundled together longitudinally.

11. The method according to claim 10, wherein the bundle consists of from 1000 to 10000 hollow fiber membranes which are bundled together longitudinally.

12. The method according to claim 10, wherein the hollow fiber membranes are chaotically bundled.

13. The method according to claim 9, wherein the molten potting material introduced into the mold is subjected to vibration prior to solidifying the potting material.

14. The method according to claim 13, wherein the vibration has at least one of:
a frequency of from 2 to 100 Hertz (Hz); and
a power density of from 10 to 200 Water per cubic centimeter (W/cm³), based on the volumetric capacity of the mold.

15. The method according to claim 13, wherein the molten potting material is subjected to vibration for a duration from 0.01 to 100 seconds prior to solidifying the potting material.

16. The method according to claim 9, wherein, solidifying the potting material in the cavity of the mold via applying a cooling rate of from 0.5 to 5 degrees Celsius per second (° C.·s⁻¹).

17. The method according to claim 9 further comprising polishing the cut portion of the solidified potting material.

18. A membrane separation module for withdrawing permeate from a multicomponent fluid feed, the module comprising:
a housing;
a plurality of hollow fiber membranes which are bundled together longitudinally to form a bundle having a core axis and defining a first axial length;
a first header disposed within the housing, the first header comprising a first potting material which is provided as a cast having a second axial length, wherein a ratio of the first axial length to the second axial length is from 1:5 to 1:50;
a second header disposed within the housing in a spaced apart relationship from the first header, the second header comprising a second potting material which is provided as a cast having a third axial length, wherein a ratio of the first axial length to the third axial length is from 1:5 to 1:50;
wherein:
the first potting material of the first header encases a first end of the bundle over the second axial length;
the second potting material of the second header encases a second end of the bundle over the third axial length; and
the first and second potting materials each consist of a tin alloy, the tin alloy consisting, on a metals basis, of:
from 95 to 97 wt. % tin (Sn); and
from 3 to 5 wt. % of a combination of Silver (Ag) with at least one of Nickel (Ni), Copper (Cu), or Germanium (Ge).

19. The membrane separation module according to claim 18, which provides a total surface area for permeation of at least 10 m².

20. The membrane separation module according to claim 18, wherein the plurality of membranes is selectively permeable to water, carbon dioxide, or methane over other gases or liquids.

21. The membrane separation module according to claim 18, wherein the plurality of membranes consists of a bundle of from 1000 to 10000 hollow fiber membranes which are bundled together longitudinally,
wherein the hollow fiber membranes have an outer diameter of from 200 to 1000 microns, a membrane thickness of from 0.1 to 20 microns and a tensile strength of from 25 to 75 Megapascals (MPa); and
further wherein the hollow fiber membranes comprise or consist of a polyimide having a selective permeability for water vapor relative to C₁ to C₄ alkanols.

22. The membrane separation module according to claim 18, wherein the plurality of membranes consists of a bundle of from 1000 to 10000 hollow fiber membranes which are bundled together longitudinally,
wherein the hollow fiber membranes have an outer diameter of from 200 to 1000 microns, a membrane thickness of from 0.1 to 20 microns and a tensile strength of from 25 to 75 Megapascals (MPa); and
further wherein the hollow fiber membranes comprise or consist of a polyimide having a selective permeability for water vapor relative to ethanol (C₂H₅OH).
